(19) United States
(12) Patent Application Publication
(10) Pub. No.: US 2019/0119549 A1
(43) Pub. Date: Apr. 25, 2019

(54) A New Anti-Foaming Composition

(71) Applicant: EMERY OLEOCHEMICALS GMBH, Düsseldorf (DE)

(72) Inventor: Diana Maeker, Mettman (DE)

(73) Assignee: EMERY OLEOCHEMICALS GMBH, Düsseldorf (DE)

(21) Appl. No.: 16/097,846

(22) PCT Filed: May 25, 2016
(86) PCT No.: PCT/EP2016/061849

§ 371 Date: Oct. 31, 2018

(51) Int. Cl. C09K 8/08; C09K 8/86; C09K 8/60; C09K 8/54; B01D 19/04

(52) U.S. Cl. CPC C09K 8/08; C09K 8/86; C09K 2208/26; C09K 8/54; B01D 19/0404; C09K 8/602

(57) ABSTRACT

The present invention relates to an anti-foaming composition comprising an alkoxylated stand oil and/or an alkoxylated blown native oil and use thereof as an anti-foaming agent.

The present invention relates to an anti-foaming composition comprising an alkoxylated stand oil and/or an alkoxylated blown native oil and use thereof as an anti-foaming agent.

### BACKGROUND OF THE INVENTION

In industrial processes, foams pose serious problems. They cause, for instance, defects on surface coatings, prevent the efficient filling of containers and prevent the efficient usage of a, preferably brine-based, drilling fluid.

A defoamer or an anti-foaming agent is a chemical additive that reduces and hinders the formation of foam in industrial process liquids. The terms anti-foaming agent and defoamer are used interchangeably herein and in the state of the art.

Usually, a defoamer according to the state of the art is insoluble in the foaming medium and has surface active properties. It has affinity to the air-liquid surface where it destabilizes the foam lamellas. This causes rupture of the air bubbles and breakdown of surface foam. Entrained air bubbles are agglomerated, and the agglomerated larger bubbles rise to the surface of the bulk liquid more quickly. Commonly used anti-foaming agents are water insoluble oils, such as polydimethylsiloxanes and other silicones, certain alcohols, stearates and glycols.

During the 1950s experiments with silicone based defoamers started which were based on polydimethylsiloxane (silicone oil) dispersed in water or light oil. Silicone oils worked acceptable, but caused surface disturbances in many applications. In 1963 defoamers with hydrophobic particles (hydrophobic silica) in light oil were patented.

The development of silicone based defoamers has continued, using different emulsifiers and modified silicone oils. In the early 1990s, silicone emulsion defoamers that caused less surface disturbances were used in the wood pulping industry.

Defoamers based on silicones are mostly not environmentally friendly and mostly water insoluble and dispersible defoamers.

In the oil industry water or brine based drilling fluids are used which should provide sufficient hydrostatic pressure in order to prevent formation fluids from entering into the drilled well or hole, keep the drill bit cool and clean during drilling, carry out cuttings of the drill, and suspend said cuttings while drilling is paused. Additionally, drilling fluids should reduce formation damage and limit corrosion of the drilling device. However, drilling fluids containing additives, such as lubricants and cleaner, usually generate an essential amount of foam. As a result of said foam the aforementioned technical effects cannot be achieved sufficiently enough by said drilling fluids.

WO 2010/128012 A1 discloses novel lubricity enhancing additives, a method for producing the same and use thereof.

It was preferably an object to the present invention to solve the aforementioned problems and preferably to provide an environmentally friendly and/or water soluble defoaming composition which preferably reduces the generation of foam and/or destroys the generated foam as fast as possible.

### SUMMARY OF THE INVENTION

It was an unexpected finding of the inventors that alkoxylated stand oils and/or an alkoxylated blown native oils, despite the fact that they have a detergent character, are still capable of functioning as an efficient defoamer and this even if these compounds are water-soluble.

Thus, these compounds are suitable to be used as defoaming agents for example in drilling fluids and completion fluids.

Thus, to solve the aforementioned problems, the present invention provides a drilling fluid or completion fluid comprising
(a) an alkoxylated stand oil and/or an alkoxylated blown native oil;
(b) an organic and/or inorganic salt; and
(c) optionally a surfactant.

Preferably said organic and inorganic salt is a water-soluble organic or inorganic salt.

A further aspect of the invention relates to a use of an alkoxylated stand oil and/or an alkoxylated blown native oil as defined herein as an anti-foaming agent, wherein the anti-foaming agent is preferably used in drilling fluids or completion fluids.

A further aspect of the invention relates to a method for defoaming a foam of a liquid, comprising:
i) providing a liquid with foam and
ii) adding at least one alkoxylated stand oil and/or at least one alkoxylated blown native oil according to the present invention to the liquid according to step i).

The technical problem has been, in particular, solved by the subject-matter of the independent claims. Preferred embodiments are the subject-matter of the dependent claims.

The drilling fluids or completion fluids according to the present invention are unexpectedly environmental friendly, destroying foam of liquid media, preferably aqueous solutions or suspensions, in a very efficient way and are advantageously water soluble (clear) and/or brine soluble. Additionally, the drilling fluid or completion fluid according to the present invention comprises an alkoxylated stand oil and/or an alkoxylated blown native oil which are surfactants. Usually surfactants support the formation of foam. In contrast, the aforementioned surfactants according to the present invention can be surprisingly used for effectively destroying foam of liquid media.

### DETAILED DESCRIPTION OF THE INVENTION

Before the present invention is described in detail below, it is to be understood that this invention is not limited to the particular methodology, protocols and reagents described herein as these may vary. It is also to be understood that the terminology used herein is for the purpose of describing particular embodiments only, and is not intended to limit the scope of the present invention which will be limited only by the appended claims. Unless defined otherwise, all technical and scientific terms used herein have the same meanings as commonly understood by one of ordinary skill in the art.

In the following passages different aspects of the invention are defined in more detail. Each aspect so defined may be combined with any other aspect or aspects unless clearly indicated to the contrary. In particular, any feature indicated as being preferred or advantageous may be combined with any other feature or features indicated as being preferred or advantageous.

Some documents are cited throughout the text of this specification. Each of the documents cited herein (including all patents, patent applications, scientific publications, manufacturer's specifications, instructions, DIN norms etc.), whether supra or infra, are hereby incorporated by reference in their entirety. Nothing herein is to be construed as an admission that the invention is not entitled to antedate such disclosure by virtue of prior invention.

In the following definitions of some terms are provided. These terms will, in each instance of its use, in the remainder of the specification have the respectively defined meaning and preferred meanings.

The term “alkyl” refers to a saturated straight or branched carbon chain. Preferably, an alkyl as used herein is a C₁-C₂₂ alkyl and more preferably is a C₁-C₁₀ alkyl, i.e. having 1, 2, 3, 4, 5, 6, 7, 8, 9 or 10 carbon atoms, preferably is selected from methyl, ethyl, propyl, iso-propyl, butyl, iso-butyl, tert-butyl, pentyl or hexyl, heptyl, octyl, nonyl and decyl. Alkyl groups are optionally substituted. Preferably, alkyl groups are not substituted.

The term “alcohol” refers to a compound having one or more hydroxyl groups. For example a C₈-C₃₆ alkyl alcohol is a C₈-C₃₆ alkyl substituted with one or more hydroxyl groups. A fatty alcohol as used herein refers to a linear aliphatic primary alcohol.

The term “water-soluble” as defined herein is a compound with a solubility in distilled water at 20° C. of at least 33 g/l. Conversely, “water-insoluble” is any compound with a solubility in distilled water at 20° C. of less than 33 g/l.

With the term “and/or” all members of a corresponding group are connected to each other alternatively, partially or completely commutatively. For instance, the term “A, B and/or C” is understood as “A or B or C or (A and B) or (A and C) or (B and C) or (A and B and C)”.

Within the context of the invention, “alkylene oxides” are alkyl epoxides. Preferably, alkylene oxides are C1 to C20 alkylene oxides, preferably ethylene oxide, propylene oxide, 1,2-butylene oxide, 2,3-butylene oxide, 1,2-pentylene oxide, 2,3-pentylene oxide, 1,2-hexylene oxide, 3-methyl-1,2-pentylene oxide, 2,3-octylene oxide, 4-methyl-2,3-octylene oxide, 4-methyl-1,2-hexylene oxide and/or 3-methyl-1,2-butylene oxide, with ethylene oxide and/or propylene oxide being particularly preferred. The alkylene oxides specified above are commercially available products, e.g. from BASF AG.

Within the context of the invention, “native oils” are oils of natural origin, which comprises at least one unsaturated compound, that is a compound with at least one C—C double bond, such as e.g. babussa oil, cottonseed oil, borage oil, thistle oil (=safflower oil), peanut oil, currant seed oil, hazelnut oil, herring oil, wood oil, jojoba oil, coconut oil, neatsfoot oil (pig grease), bone oil, lard oil, liver oil, linseed oil, corn oil, almond oil, olive oil, palm oil, palm kernel oil, rapeseed oil (=colza oil), beef tallow (=suet), castor oil, sardine oil, mustard seed oil, soybean oil, sunflower oil, shea butter, tall oil, grapeseed oil, whale oil and/or walnut oil. Preference is given to using refined variants thereof. The use of partially hydrogenated variants is likewise possible. All of the aforementioned oils are customary, e.g. available from Gustav Heess.

Within the context of the invention, “blown native oils” are native oils polymerized with the introduction of air, preferably by blowing in the native oils hot air at temperatures of preferably 100 to 150° C. and preferably over at least 1 h, preferably 1 h to 4 days.

As a result of the treatment, a molecule enlargement takes place via oxygen bridges, as described e.g. in the BASF handbook Lackiertechnik [Coating technology] 2002, p. 36 (ISBN 3878703244). Blown native oils typically have a kinematic viscosity (in accordance with DIN 51562) at 40° C. between 100 and 10 000 mm²/s. The aforementioned blown native oils are standard commercial products, e.g. available from Gustav Heess.

Within the context of the invention, “stand oils” are native oils polymerized with the exclusion of air and are preferably produced at temperatures of 260 to 300° C. and preferably over at least 1 h, preferably 1 h to 4 days.

As a result of the treatment, a molecule enlargement takes place via polymerization reactions of the double bonds, as described e.g. in the BASF handbook Lackiertechnik [Coating technology] 2002, p. 36 (ISBN 3878703244). Stand oils typically have a kinematic viscosity (in accordance with DIN 51562) at 40° C. between 100 and 10 000 mm²/s. The aforementioned stand oils are standard commercial products, e.g. available from Alberdingk Boley GmbH.

A “drilling fluid” refers to a fluid that is used for oil drilling in particular in the field of petroleum production. A “completion fluid” is suitable to make an oil well ready for production or injection.

In a first aspect the invention provides a drilling fluid or completion fluid comprising
(a) an alkoxylated (most preferably ethoxylated) stand oil and/or an alkoxylated (most preferably ethoxylated) blown native oil;
(b) a, preferably water soluble, organic and/or inorganic salt; and
(c) optionally a surfactant.

Preferably, the present invention relates to a drilling fluid or completion fluid according to the present invention, wherein the native oil is selected from the group consisting of babussa oil, cottonseed oil, borage oil, safflower oil, peanut oil, blackcurrant seed oil, hazelnut oil, herring oil, tung oil, jojoba oil, coconut oil, neat's foot oil, bone oil, lard liver oil, linseed oil, corn oil, almond oil, olive oil, palm oil, palm kernel oil, rapeseed oil, beef tallow, castor oil, sardine oil, mustard oil, soybean oil, sunflower oil, shea butter oil, tall oil, grapeseed oil, whale oil, walnut oil, thistle oil, wood oil, a partially hydrogenated version of any of the aforementioned oils, a refined version of any of the aforementioned oils, a transesterification product of any of the aforementioned oils and mixtures thereof. Preferably, the blown native oils is blown rapeseed oil (=blown colza oil). Most preferably, the alkoxylated blown native oil is an ethoxylated blown rapeseed oil.

The alkoxylated stand oil and/or an alkoxylated blown native oil is preferably esterified or trans-esterified by fatty acids, preferably by saturated and/or unsaturated as well as branched and/or unbranched fatty acids, having preferably 6 to 21 carbon atoms, hydroxyl fatty acids, preferably ricinolic acid, and/or ether carboxylic acids.

The drilling fluid or completion fluid comprises preferably at least one, preferably exactly one, preferably at least two different, preferably exactly two different, alkoxylated stand oils and/or preferably at least one, preferably exactly one, preferably at least two different, preferably exactly two different, alkoxylated blown native oils. The drilling fluid or completion fluid comprises preferably at most ten different, preferably at most five different, alkoxylated stand oils and/or preferably at most ten different, preferably at most five different, different, alkoxylated blown native oils. The drilling fluid or completion fluid comprises preferably at least one and at most ten different, preferably at least two and at most five different, alkoxylated stand oils and/or preferably at least one and at most ten different, preferably at least two and at most five different, different, alkoxylated blown native oils.

Preferably, the drilling fluid or completion fluid consists of components (a), (b) and (c). Most preferred is a drilling fluid or completion fluid consisting of components (a) and (b).

Preferably, the present invention relates to a drilling fluid or completion fluid according to the present invention, wherein the stand oil is a native oil polymerized under the exclusion of air.

Preferably, the present invention relates to a drilling fluid or completion fluid according to the present invention, wherein the blown native oil is native oil polymerized by blowing air into the oil.

Preferably, the present invention relates to a drilling fluid or completion fluid according to the present invention, wherein the stand oil has a kinematic viscosity at 40° C. of between 100 and 10 000 mm²/s when determined in accordance with DIN 51562.

Preferably, the present invention relates to a drilling fluid or completion fluid according to the present invention, wherein the alkoxylated stand oil and/or the alkoxylated blown native oil is producible by reacting at least one alkylene oxide with a stand oil and/or blown native oil. Preferably, the alkoxylated stand oil is producible by reacting at least one alkylene oxide with a stand oil. Preferably, the alkoxylated blown native oil is producible by reacting at least one alkylene oxide with a blown native oil.

Preferably, the present invention relates to a drilling fluid or completion fluid according to the present invention, wherein the alkylene oxide is ethylene oxide, propylene oxide, 1,2-butylene oxide, 2,3-butylene oxide, 1,2-pentylene oxide, 2,3-pentylene oxide, 1,2-hexylene oxide, 3-methyl-1,2-pentylene oxide, 2,3-octylene oxide, 4-methyl-2,3-octylene oxide, 4-methyl-1,2-hexylene oxide and/or 3-methyl-1,2-butylene oxide and/or mixtures thereof.

Preferably, the present invention relates to a drilling fluid or completion fluid according to the present invention, wherein said drilling fluid or completion fluid further comprises an additive selected from the group consisting of a viscosity modifier, a corrosion inhibitor, an antiwear agent, an organic solvent, a gel-breaking surfactant, a lubricant, a cleaner and mixtures thereof.

Preferably, the present invention relates to a drilling fluid or completion fluid according to the present invention, wherein the alkoxylated stand oil and/or alkoxylated blown native oil is water soluble.

Preferably, the present invention relates to a drilling fluid or completion fluid according to the present invention, wherein the inorganic salt comprises a cation which is selected from the group consisting of an alkali metal ion, an alkaline earth metal ion, a transition metal ion and mixtures thereof. Preferably, the cation is selected from the group consisting of potassium, caesium, calcium, magnesium and zinc and mixtures thereof. Preferably, the inorganic salt comprises as anion chloride and preferably at least one of the aforementioned cations. Preferably said organic and inorganic salt is a water-soluble organic or inorganic salt. In particular preferred salts are selected from the group consisting of KCl, CsCl, NaCl, CaCl₂, KBr and CaBr₂.

Preferably, the organic salt comprises an anion which is selected from the group consisting of formiate, oxalate, nitrate, glycolate, lactate, acetate and mixtures thereof. The formiate is preferably CsCOOH or KCOOH.

Preferably, the drilling fluid or completion fluid comprises at least 10% by weight, preferably at least 20% by weight organic and/or inorganic, preferably water soluble, salts.

Preferably, the drilling fluid or completion fluid comprises the alkoxylated stand oil and/or the alkoxylated blown native oil in an amount of at least 0.05% by volume, preferably at least 0.1% by volume, preferably at least 0.5% by volume, preferably 0.05% by volume to 4% by volume, preferably 0.1% by volume to 3% by volume, preferably 0.5% by volume to 2% by volume. More preferably, the drilling fluid or completion fluid comprises the alkoxylated stand oil and/or the alkoxylated blown native oil in an amount of 0.1 by volume % to 4% by volume. Most preferred is a drilling fluid or completion fluid comprising the alkoxylated stand oil and/or the alkoxylated blown native oil in an amount of 0.1 by volume % to 1% by volume, preferably 0.3 by volume % to 0.7% by volume.

Preferably, the drilling fluid or completion fluid comprises the alkoxylated stand oil and/or the alkoxylated blown native oil in an amount of at least 0.05% by weight, preferably at least 0.1% by weight, preferably at least 0.5% by weight, preferably 0.05% by weight to 4% by weight, preferably 0.1% by weight to 3% by weight, preferably 0.5% by weight to 2% by weight. More preferably, the drilling fluid or completion fluid comprises the alkoxylated stand oil and/or the alkoxylated blown native oil in an amount of 0.1 by weight % to 4% by weight. Most preferred is a drilling fluid or completion fluid comprising the alkoxylated stand oil and/or the alkoxylated blown native oil in an amount of 0.1 by weight % to 1% by weight, preferably 0.3 by weight % to 0.7% by weight.

Preferably, the drilling fluid or completion fluid comprises the surfactant in an amount of at least 0.1% by volume, preferably at least 0.5% by volume, preferably 0.1% by volume to 4% by volume, preferably 0.5% by volume to 2% by volume, most preferably 0.3% by volume to 0.7% by volume.

Preferably, the drilling fluid or completion fluid comprises the surfactant in an amount of at least 0.1% by weight, preferably at least 0.5% by weight, preferably 0.1% by weight to 4% by weight, preferably 0.5% by weight to 2% by weight, most preferably 0.3% by weight to 0.7% by weight.

Preferably, the alkoxylated stand oil and/or the alkoxylated blown native oil is/are (an)other chemical substance(s) than the surfactant according to (c).

All components comprised in the drilling fluid or completion fluid add up to 100% by weight.

Preferably, the present invention relates to a drilling fluid or completion fluid according to the present invention, wherein said drilling fluid or completion fluid is an aqueous solution or suspension, preferably an aqueous solution.

The alkoxylated stand oil and/or an alkoxylated blown native oil is/are preferably produced by the alkoxylation (reaction with the alkylene oxide) of at least one stand oil and/or at least one blown native oil in the presence of a catalyst.

Preferably, the reaction with the alkylene oxide takes place in the ratio of 1 to 99% by weight of stand oil and/or blown native oil to 99 to 1% by weight of alkylene oxide. The ratio depends on the intended water miscibility. Particular preference is given to the ratio of 30 to 50% by weight of stand oil and/or blown native oil to 70 to 50% by weight of alkylene oxide. Particular preference is given here to the reaction product of blown rapeseed oil with ethylene oxide. Very particular preference is given then to a ratio of 30 to 50% by weight of blown rapeseed oil to 70 to 50% by weight of ethylene oxide.

Preferably, the reaction with the alkylene oxide takes place in a molar ratio of 1 to 99 stand oil and/or blown native oil to 99 to 1% of alkylene oxide. The ratio depends on the intended water miscibility. Particular preference is given to a molar ratio of 30 to 50% of stand oil and/or blown native oil to 70 to 50% of alkylene oxide. Particular preference is given here to the reaction product of blown rapeseed oil with ethylene oxide. Very particular preference is given then to a molar ratio of 30 to 50% of blown rapeseed oil to 70 to 50% of ethylene oxide.

The alkoxylated stand oil and/or an alkoxylated blown native oil is preferably produced at a temperature of 100 to 190° C. and a pressure of 1 to 6 bar using a nucleophilic catalyst. Nucleophilic catalysts are preferably alcoholates, preferably alkali metal alcoholates, particularly preferably sodium methanolate, hydroxides, preferably sodium hydroxide, or amines, such as triethanolamine. The reaction temperature is preferably in the range from 140 to 180° C., particularly preferably 160 to 180° C. The catalyst used is preferably alkali metal alcoholates, particularly preferably sodium methanolate.

In the reaction detailed above, the stand oil, the blown native oil or a mixture of the two oils can be used. Preferably, the reaction takes place with the alkylene oxide in a ratio of 1 to 99% by weight of stand oil and/or blown native oil to 99 to 1% by weight of alkylene oxide. Particular preference is given to a ratio of 30 to 50% by weight of stand oil and/or blown native oil to 70 to 50% by weight of alkylene oxide.

Preferably, the present invention relates to a drilling fluid or completion fluid according to the present invention, wherein said surfactant is selected from the group consisting of an alkoxylated fatty alcohol, an ether carboxylic acid, alkyl polyglycosides (abbreviated as APG), ether sulfates, sulfates and alkoxylated ester. Preferably, the surfactant is a C₈ fatty alcohol in combination with, preferably 4 mol, ethylene oxide. Alternatively or additionally, the surfactant is preferably an ethoxylated C₁₈ fatty alcohol ether carboxylic acid.

The present invention relates also to a use of the alkoxylated stand oil and/or the alkoxylated blown native oil as defined herein as an anti-foaming agent.

Preferably, the present invention relates to a use according to the present invention, wherein the alkoxylated stand oil and/or the alkoxylated blown native oil is used to defoam a brine-based drilling fluid, a completion fluid, a cleaning fluid, a lubricating fluid, a fracking fluid or a workover fluid.

Preferably, the alkoxylated stand oil and/or the alkoxylated blown native oil is used in order to inhibit foam, preferably in an aqueous medium, preferably solution or suspension, for oilfield drilling applications.

Preferably, the present invention relates to a use according to the present invention, wherein the brine-based drilling fluid comprises at least 10 wt %, preferably at least 20 wt % organic and/or inorganic, preferably water soluble salts.

The drilling fluid or completion fluid according to the present invention is preferably free of silicone, preferably free of a silicone oil. Additionally or alternatively, the drilling fluid or completion fluid is preferably free of a siloxane, preferably a modified siloxane.

The present invention also relates to a method of defoaming a foam of a liquid, comprising:
i) providing a liquid, preferably an aqueous solution or suspension, with foam and
ii) adding at least one alkoxylated stand oil and/or at least one alkoxylated blown native oil according to the present invention to the liquid, preferably with foam, according to step i).

Preferably, step ii) is performed prior, during and/or after step i). By adding the at least one alkoxylated stand oil and/or the at least one alkoxylated blown native oil or the drilling fluid or completion fluid according to the present invention to a liquid suitable for generating foam or comprising foam, the generation of foam is prevented and/or the generated foam collapse more quickly than without adding the at least one alkoxylated stand oil and/or the at least one alkoxylated blown native oil or the drilling fluid or completion fluid according to the present invention. The liquid according to step i) is preferably a brine-based drilling fluid, a completion fluid, a cleaning fluid, a lubricating fluid, a fracking fluid or a workover fluid.

The alkoxylated stand oil and/or the alkoxylated blown native oil or the drilling fluid or completion fluid according to the present invention act(s) preferably as anti-foaming agent, in order to prevent generation of foam of a liquid, preferably an aqueous solution or suspension, and/or to de-foam the generated foam.

Preferably, the alkoxylated stand oil and/or the alkoxylated blown native oil or the drilling fluid or completion fluid according to the present invention reduces the generated foam by at least 50% by volume, preferably at least 60% by volume, preferably at least 70% by volume, preferably measured according to Example 1 of the present invention, preferably by adding 100 ml of an aqueous test solution (dest. Water+[3% by volume, preferably ethoxylated saturated, fatty alcohol C8+4 mol ethylene oxide (EO)] (for instance Dehydol® O4) and 0.5% by volume (=0.5 ml) of the alkoxylated stand oil and/or the alkoxylated blown native oil or the drilling fluid or completion fluid according to the present invention into a 250 ml measuring cylinder, shaking vigorously as long as the measuring cylinder is completely filled with liquid and foam, measuring the volume of the foam directly and 1 min after shaking and calculating the foam reduction.

Preferably, the alkoxylated stand oil and/or the alkoxylated blown native oil or the drilling fluid or completion fluid according to the present invention is added to the foam generating liquid in an amount of at least 0.05% by volume, preferably at least 0.1% by volume, preferably at least 0.5% by volume, preferably at least 3% by volume, preferably 0.05% by volume to 4% by volume, preferably 0.1% by volume to 3% by volume, preferably 0.5% by volume to 2% by volume, more preferably 0.1 by weight % to 4% by weight, most preferably 0.1 by weight % to 1% by weight, most preferably 0.3 by weight % to 0.7% by weight.

Preferably, the surfactant is present in the drilling fluid or completion fluid in an amount of at least 0.1% by volume, preferably at least 0.5% by volume, preferably 0.1% by volume to 4% by volume, preferably 0.5% by volume to 2% by volume, most preferably 0.3 by weight % to 0.7% by weight.

Various modifications and variations of the invention will be apparent to those skilled in the art without departing from the scope of the invention. Although the invention has been described in connection with specific preferred embodiments, it should be understood that the invention as claimed should not be unduly limited to such specific embodiments.

The following examples are merely illustrative of the present invention and should not be construed to limit the scope of the invention as indicated by the appended claims in any way.

### Examples

### 1. Anti-Foaming Performance

100 ml of an aqueous test solution (dest. Water+3 Vol-% (% by volume) of an ethoxylated saturated fatty alcohol [saturated C₈ fatty alcohol+4 mol ethylene oxide (EO), (Dehydol O4 by BASF)] has been filled into a 250 ml measuring cylinder.
Different additives have been added (0.5 Vol-%=0.5 ml) into the measuring cylinder and mixed with the aqueous test solution.
Test 1: No additive has been added
Test 2: Additive A=Additin RC 5010, an ethoxylated blown rapeseed oil, viscosity (40° C.;
DIN 51562)=750 mm²/sec; density (25° C.; DIN 51757)=1.06 g/cm³;
melting point=<−5° C. at 1,013 hPa (ex Rheinchemie)
Test 3: Additive B=Wacker L053 silicone oil, a 100% polyether functional polydimethylsiloxane (ex Wacker)
Test 4: Additive C=Tego Antifoam 793, being based on a modified polyetherpolysiloxane (ex Evonik)
Each cylinder has been shaken per hand for 1 min. After 1 and 2 minutes the foam level was noted. The results are shown in table 1.

TABLE 1

| | | Test 2 | Test 3 | Test 4 |
|---|---|---|---|---|
| | | Aqueous test | Aqueous test | Aqueous test |
| | Test 1 | solution + | solution + | solution + |
| | Aqueous test | 0.5 Vol.-% | 0.5 Vol.-% | 0.5 Vol.-% |
| | solution | Additive A | Additive B | Additive C |
| After | >160 ml foam | 30 ml foam | >160 ml foam | 100 ml foam |
| 1 min | | | | |
| After | 134 ml foam | 0 ml foam | 112 ml foam | 92 ml foam |
| 2 min | | | | |

Test 2 (inventive defoamer) shows that no foam is present after 2 min. In contrast thereto, in tests 3 and 4 the same amount of additives used could not reduce the foam considerably in the same amount of time.

### 2. Turbidity

The turbidity (measured in form of formazin nephelometric units (FNU)) of the aqueous compositions according to Example 1 have been determined at 20° C. using the ISO 7027 turbidity method (see table 2).

TABLE 2

| | | Aqueous test | Aqueous test | Aqueous test |
|---|---|---|---|---|
| | | solution + | solution + | solution + |
| | Aqueous test | 0.5 Vol.-% | 0.5 Vol.-% | 0.5 Vol.-% |
| | solution | Additive A | Additive B | Additive C |
| FNU | 41.1 | 15.5 | 3.3 | >500 |
| | | | | (not measurable |
| | | | | because of |
| | | | | precipitation) |

Without wishing to be bound to a theory the lower FNU value of the test solution 2 and 3 (compared to the aqueous solution) might result from a synergy effect of the foaming surfactant (octanol+4 EO) and the additives A or B. The additives A and B (defoamer) are also surface active substances, which helps to provide clearer solutions.
The inventive Additive A (test 2) is water-soluble as it can be seen from the FNU value of table 2.

1. A drilling fluid or completion fluid comprising
(a) an alkoxylated stand oil and/or an alkoxylated blown native oil;
(b) an organic and/or inorganic salt; and
(c) optionally a surfactant.

2. The drilling fluid or completion fluid according to claim 1, wherein the native oil is selected from the group consisting of babussa oil, cottonseed oil, borage oil, safflower oil, peanut oil, blackcurrant seed oil, hazelnut oil, herring oil, tung oil, jojoba oil, coconut oil, neat's foot oil, bone oil, lard liver oil, linseed oil, corn oil, almond oil, olive oil, palm oil, palm kernel oil, rapeseed oil, beef tallow, castor oil, sardine oil, mustard oil, soybean oil, sunflower oil, shea butter oil, tall oil, grapeseed oil, whale oil, walnut oil, thistle oil, wood oil, a partially hydrogenated version of any of the aforementioned oils, a refined version of any of the aforementioned oils, a transesterification product of any of the aforementioned oils and mixtures thereof.

3. The drilling fluid or completion fluid according to claim 1, wherein the stand oil is a native oil polymerized under the exclusion of air.

4. The drilling fluid or completion fluid according to claim 3, wherein the stand oil has a kinematic viscosity at 40° C. of between 100 and 10 000 mm²/s when determined in accordance with DIN 51562.

5. The drilling fluid or completion fluid according to claim 1, wherein the alkoxylated stand oil and/or an alkoxylated blown native oil is producible by reacting at least one alkylene oxide with said stand oil and/or blown native oil.

6. The drilling fluid or completion fluid according to claim 1, wherein the blown native oil is native oil polymerized by blowing air into the oil.

7. The drilling fluid or completion fluid according to claim 5, wherein the alkylene oxide is selected from the group consisting of ethylene oxide, propylene oxide, 1,2-butylene oxide, 2,3-butylene oxide, 1,2-pentylene oxide, 2,3-pentylene oxide, 1,2-hexylene oxide, 3-methyl-1,2-pentylene oxide, 2,3-octylene oxide, 4-methyl-2,3-octylene oxide, 4-methyl-1,2-hexylene oxide and 3-methyl-1,2-butylene oxide.

8. The drilling fluid or completion fluid according to claim 1, wherein said drilling fluid or completion fluid further comprises an additive selected from the group consisting of a viscosity modifier, a corrosion inhibitor, an antiwear agent, an organic solvent, a gel-breaking surfactant, a lubricant, a cleaner and mixtures thereof.

9. The drilling fluid or completion fluid according to claim 1, wherein the alkoxylated stand oil and/or alkoxylated blown native oil is water soluble.

10. The drilling fluid or completion fluid according to claim 1, wherein said inorganic salt comprises a cation which is selected from the group consisting of an alkali, an alkaline earth salt, a transition metal and mixtures thereof; and
wherein the organic salt comprises an anion which is selected from the group consisting of formiate, oxalate, nitrate, glycolate, lactate and acetate.

11. The drilling fluid or completion fluid according to claim 1, wherein said drilling fluid or completion fluid is an aqueous solution.

12. The drilling fluid or completion fluid according to claim 1, wherein said surfactant is selected from the group consisting of an alkoxylated fatty alcohol, an ether carboxylic acid, alkyl polyglycosides, ether sulfates, sulfates and alkoxylated ester.

13. An anti-foaming agent comprising an alkoxylated stand oil and/or an alkoxylated blown native oil as defined in claim 1.

14. The anti-foaming agent according to claim 13, wherein the alkoxylated stand oil and/or the alkoxylated blown native oil is used to defoam a brine-based drilling fluid, a completion fluid, a cleaning fluid, a lubricating fluid, a fracking fluid or a workover fluid.

15. The anti-foaming agent according to claim 14, wherein the brine-based drilling fluid comprises at least 10 wt % organic or inorganic, water soluble salts.

16. A method of defoaming the foam of a liquid, comprising:
i) providing a liquid with foam and
ii) adding at least one alkoxylated stand oil and/or at least one alkoxylated blown native oil according to claim 9 to the liquid according to step i).

17. The method according to claim 16, wherein the liquid is an aqueous solution or suspension.

18. The method according to claim 16, wherein step ii) is performed prior, during and/or after step i).
